(19) United States
(12) Patent Application Publication
(10) Pub. No.: US 2010/0098929 A1
(43) Pub. Date: Apr. 22, 2010

(54) Impact resistant composite material

(76) Inventor: John Anthony Dispenza, Long Valley, NJ (US)

Correspondence Address: Docket Administrator - Room 3D-201E;Alcatel-Lucent USA Inc., 600-700 Mountain Avenue, Murray Hill, NJ, 07974, US

(21) Appl. No.: 11/178,831

(22) Filed: Jul. 11, 2005

(51) Int. Cl. B32B 5/28; B29C 45/14

(52) U.S. Cl. 428/292.1; 156/245

(57) ABSTRACT

An impact-resistant structure such as a lightweight armor plate includes a woven cloth at least partially permeated with a thermoplastic resin and laminated to a thermoplastic plate or other body

### FIELD OF THE INVENTION

This invention relates to structural articles made from composite materials, and more particularly to laminated articles that include resin-infused cloth.

### ART BACKGROUND

Impact-resistant panels have many uses, which include the protection of enclosures for communications equipment, vehicles, and personnel. For these and other purposes, desirable attributes include light weight, low volume, and low cost.

Generally, protection for equipment and vehicles is provided by panels of metal or ceramics. These suffer from the disadvantage that they are relatively heavy, and particularly in the case of ceramics, may also be relatively expensive.

Armor panels for the protection of personnel, which are desirably light in weight, are often made from composite materials that include a cloth permeated with a resin. Kevlar® (a registered trademark of E.I. Dupont de Nemours, Inc.), for example, is a woven cloth of strong organic fibers that has been permeated with a thermosetting epoxy resin. Although such panels have proven extremely effective, high levels of protection from firearms generally require many layers of protective material. The result is armor that is both bulky and relatively expensive.

Military vests for protection from high-level ballistic threats incorporate ceramic plates. Such components add undesirable weight and reduce flexibility.

Thus, there remains a need for panels or other structures that provide protection against impact from gunfire and other threats, while achieving a better tradeoff among effectiveness, cost, weight, and volume.

### SUMMARY OF THE INVENTION

I have developed a protective structure that can achieve an improved tradeoff among the factors listed above. My new structure includes a woven cloth at least partially permeated with a thermoplastic resin and laminated to a thermoplastic plate or other body.

In specific embodiments, my invention involves a structure as described above.

In other specific embodiments, my invention involves a method for manufacturing such a structure, as will be described below.

### BRIEF DESCRIPTION OF THE DRAWING

FIG. 1 is a flowchart of one possible process sequence for manufacturing an impact-resistant article.

FIG. 2 is a simplified perspective drawing of an injection mold in open configuration. A preform is shown inside the mold.

FIG. 3 is a simplified perspective drawing of an injection mold in closed configuration. The preform of FIG. 2 is shown center-justified inside the mold cavity.

FIG. 4 is an exploded view of an illustrative article made according to the present invention.

FIG. 5 is a perspective view of an illustrative article made according to the present invention.

### DETAILED DESCRIPTION

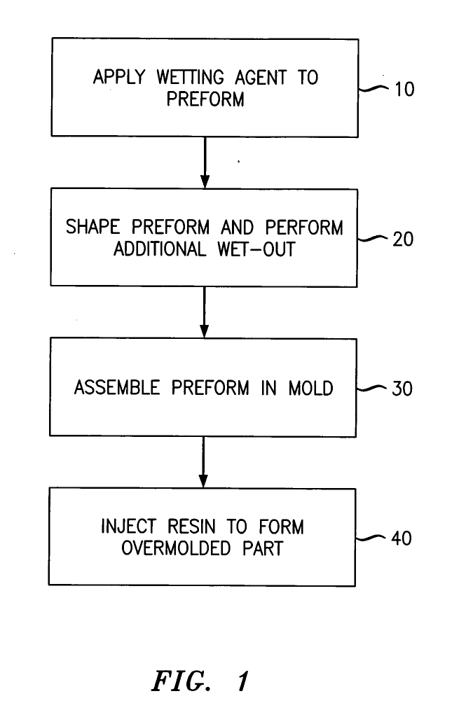

FIG. 1 shows one possible process sequence for manufacturing an impact-resistant article. At step 10, a cloth or mat of appropriate material is wetted-out with an emulsion such as a softened or liquefied resin. I found that three-dimensional woven fiberglass cloth is especially useful in this regard. Depending on the specific application, alternatives that may also be useful include Kevlar® or Spectra® or other Aramid or high-modulus polyethylene fibers, although cloths of these fibers may be significantly more expensive than fiberglass. (Spectra® is a registered trademark of Honeywell Performance Fibers.)

Wetting-out means impregnating the cloth or mat with a liquid wetting agent, or emulsion, at least to such extent that when the liquid hardens, the cloth or mat will be stiff enough to maintain its shape during the lamination or overmolding step to be described below. The stiffened cloth or mat is referred to as a preform. Preforms typically follow the centerline geometry of the molded part or of the cavity (i.e. of the molding tool) that creates the part.

For a wetting agent, it is advantageous to use a thermoplastic emulsion that is chemically compatible with the other materials, including the overmolding resin, and that softens at a temperature below the liquefying or injection-processing temperature of the overmolding material. (By “resin” is meant a polymeric material that flows under stress and that softens or melts in a certain temperature range.) I have found that organic polymers such as starch, various paraffins, or wax work well as emulsion materials. In addition, polymethyl methacrylate (PMMA), styrenes, and polymeric alloys have been tried successfully. Depending on the particular choice of material system, other possibilities include, without limitation, polyvinyls, polybutylene, polyesters, and at least some thermoplastic polyurethanes. Any of various well known methods may be used to apply the wetting agent, including, without limitation, spraying, painting, resin-transfer molding, resin-film infusion, and immersion.

At step 20, the preform is shaped, e.g. by placing it on a drape mold, and treated on the interfacial surface or surfaces with a wetting agent selected to promote adhesion between the preform and the molded part. (By “interfacial surfaces” is meant those surfaces that will be bonded to the molded part.) When hardened, the emulsion or wetting agent allows the preform to retain the shape of the drape mold, which is advantageous for handling purposes and for shape retention within the injection mold cavity to facilitate the overmold process.

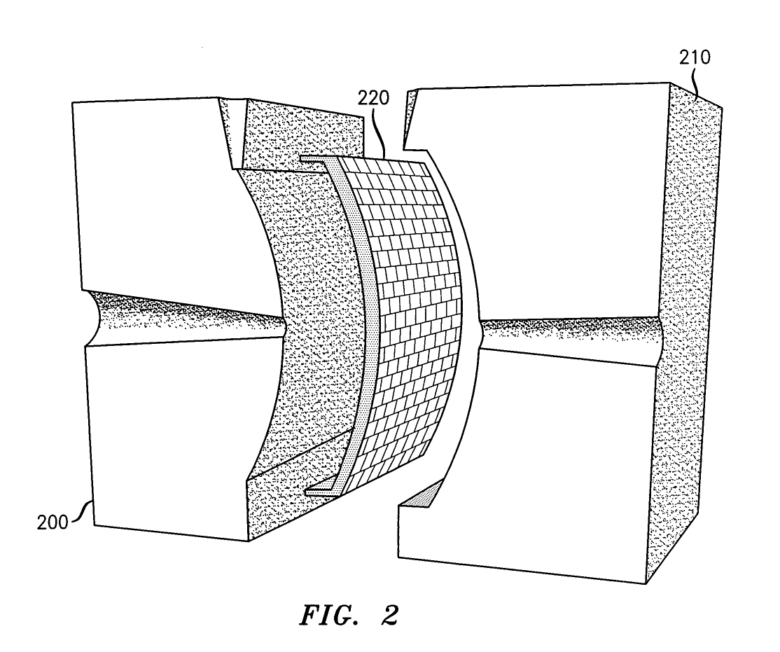

At step 30, the preform is placed in the mold and the mold is closed. As shown in FIG. 2, an exemplary mold includes two mating segments, namely, core segment 200 and cavity segment 210. Preform 220 is positioned within the mold between core 200 and cavity 210. The cavity side of the mold is sometimes referred to as the “A” side or “appearance” side, and the core side of the mold is sometimes referred to as the “B” side or “non-appearance” side.

Various well-known agents may be applied between the preform and the core to facilitate adhesion for proper alignment while setting up for the molding process, as well as to facilitate release after molding. Such agents may include, without limitation, adhesives, sprays, caulking, or tapes. Simple vacuum suction may also be usefully employed. For molded parts requiring that the injection molding resin be on both sides of the preform, standoffs, spacers, or shims (permanent or sacrificial) can create a predetermined space or gap between the rear side of the preform and the core mold. In this manner, thermoplastic resins can be injected on both sides of the preform to create complex geometries. Such geometries may include, e.g., support ribs, posts, screw bosses, and snap features. Such features may, e.g., facilitate the assembly of impact-resistant molded parts to other structures such as ground vehicles, aircraft, communications equipment, personnel stations, and body armor.

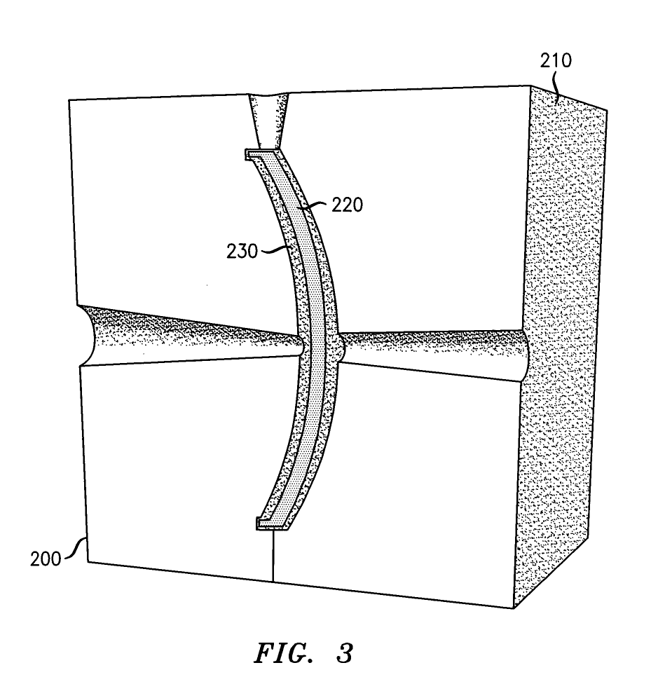

When the core and cavity segments of the mold are brought together, as shown in FIG. 3, a void space 230 is defined between the mold surfaces and the preform. As is well known in the art, void space 230 will be injected with heated and liquefied overmolding material during the molding process.

Turning back to FIG. 1, the molded part is formed at step 40 by, e.g., low pressure or high pressure injection molding or by structural foam molding. The molded part is formed of a high-impact-strength thermoplastic. One thermoplastic resin useful for this purpose is rubber impact modified polycarbonate. Depending on the specific application, other useful thermoplastics may include polyvinyl chloride, polysulfone, polyetherimide, polyesters, polyurethanes, nylons, and alloys such as PC/ABS.

For high pressure injection molding, the process parameters include processing temperature of the material (in the injection screw barrel and in the nozzle), mold temperature, injection pressure, and cycle times.

For low pressure injection molding, a chemical or gas blowing agent may be added to the process to foam the resin, thereby to reduce the density of the material and enable thicker walls to form.

Methods of high and low pressure injection molding are well known and need not be described here in detail. However, it should be noted that adhesion between the preform and the molded part may be sensitive to certain process parameters. In our trials of overmolding polycarbonate onto starch-permeated or acrylic-permeated fiberglass cloth, we found that certain adjustments of the process parameters led to good adhesion.

Specifically, good adhesion was obtained with a resin processing temperature (for polycarbonate resin) in the approximate range 450° F.-500° F., a temperature of the wetting emulsion in the approximate range 220° F.-250° F. (typically, about one-half the Fahrenheit temperature of the resin), an elevated injection pressure for both the low pressure and the high pressure injection-molding processes, and slightly increased cycle times to promote formation of a consistent product cross section with few or no voids and a relatively high degree of molecular orientation.

In the temperature range that we used, it therefore appeared advantageous for the resin processing temperature to be about 200° F.-250° F. greater (or about 30%-35% greater on an absolute temperature scale) than the wetting emulsion temperature. An elevated injection pressure, in regard to our exemplary process conditions, may be, e.g., about 25% higher than the resin manufacturer's recommendation. Such elevated pressure is useful to force resin into interstices of the roving, and augment chemical adhesion by adding mechanical locking behavior. A slightly increased cycle time in this regard may be, e.g., 10%-15% longer than the resin manufacturer's recommendation.

We believe that in general, thermoplastic wetting agents will be chemically compatible with many amorphous injection molding resins and will exhibit good adhesion.

It should be noted that the mat or cloth for the preform may be used in a single ply or in multiple plies. It should be noted further that known techniques, including repetitions of the overmolding process described above, can be used to build up a composite article that includes multiple layers of mat or cloth and multiple molded thermoplastic layers. A composite article may also include layers of further materials, applied by overmolding or by other processes. Such materials may include other polymeric materials, such as thermoset resins, as well as materials such as ceramic or metal. In particular, strike-face materials may be included. Strike-face materials are ceramic or other materials that are extremely hard, typically of only slightly less than diamond hardness. One use of strike-face materials is to shatter or deform bullets or other projectiles on impact with the strike-face material. Compositions of strike-face materials may include silicon carbide, aluminum oxide, boron carbide, or zirconia.

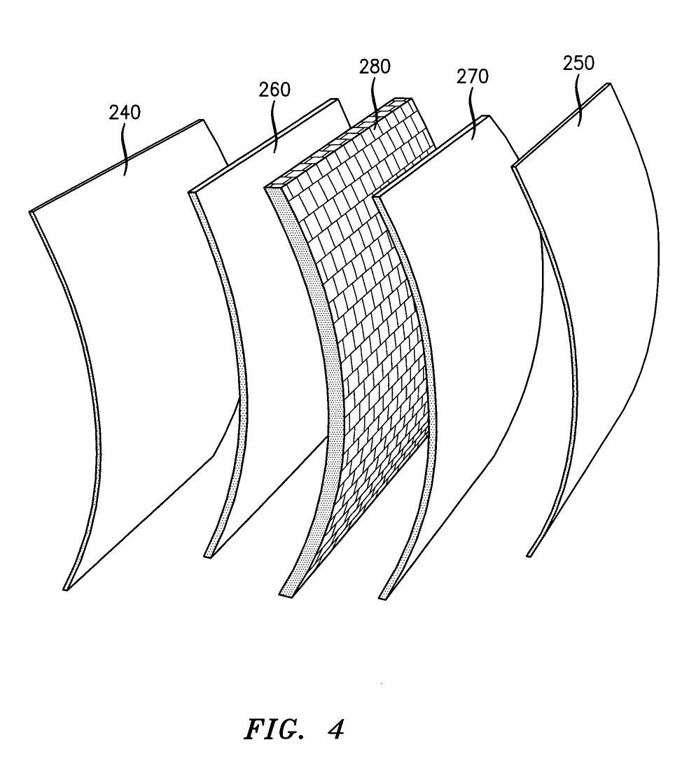

FIG. 4 is an exploded view of a molded article including resin layers 240 and 250 situated outermost, cloth layers 260 and 270 situated adjacent respective resin layers, and plate 280 of strike-face material situated between and adjacent to the cloth layers.

It should also be noted that the overmolding process described above is merely illustrative, and that other processes for forming a laminated composite article may also be used. One well-known alternative molding process is compression molding, which is carried out using semi-solid plastics and high clamp force. Still other processes are known, in which multiple thermoplastic resins are injected into a mold. For example, in co-injection, two materials are injected using two feeds. In twin shot molding, two materials are injected using only one feed. Such processes, among others, are useful for forming complex shapes from two or more engineering resins over a structural preform.

Furthermore, any of various non-injective processes may be used to compressively form sheets of thermoplastic resin and join them to both sides of a preform. Such an approach is especially useful when making an article prohibitively large for injection molding. Well-known techniques useful in this regard include vacuum molding, twin sheet forming, pressure molding, vacuum bag molding, and other methods of vacuum forming and pressure forming.

### Example

I have made several composite panels of polycarbonate, starch, and fiberglass by the techniques described above. In ballistics tests using small-arms fire, my panels exhibited a surprising amount of impact resistance, relative to comparable panels made using thermosetting resin.

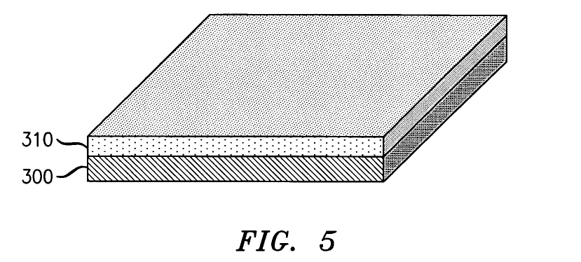

My composite panel is illustrated in FIG. 5. The figure is merely schematic and is not drawn to scale. Layer 300 was initially prepared as a fiberglass-starch preform. The glass cloth had a three-dimensional weave in which the loom added a woven roving stitching in the z-direction to a weave in the x- and y-directions. To make the preforms, the cloth was cut to size and wetted-out with a low temperature wetting agent made from starch. (In other test panels, PMMA was successfully used for the wetting agent.) The wetting agents were melted in a pressure pot as described above to create a liquid for both immersion and brush-on application to the cloths. All preforms were completely wetted out before being placed on a drape mold which followed the geometry of the core-half molding tool.

Once the liquid dried in the preform cloth, the preform was able to hold its shape for handling and placement in the production injection mold. Polycarbonate injection molding resins were selected to overmold the preforms. The polycarbonate resins contained a synthetic rubber compound to improve the impact strength, especially in the lower temperature ranges, i.e., those near the cold-to-brittleness transition.

With further reference to FIG. 5, layer 310 of the finished article is indicative of the polycarbonate overmolding resin. Layer 310 was formed by overmolding layer 300, which comprises emulsion-containing cloth, in a high pressure injection mold at a melt temperature of about 450° F. The thickness of layer 310 in the finished article was 0.188 inches (0.478 cm). Greater thicknesses can be produced by, e.g., adding chemical or gas foaming agents to a single injection molding shot, or by injecting resin in multiple cycles.

Although the figure shows a resin layer 310 formed on only one side of cloth layer 300, it will be appreciated that well-known molding techniques are readily used to form resin layers on both sides of the cloth layer or to completely encase the cloth layer in resin.

Several essentially identical panels of the composite material of FIG. 3 were subjected to small-arms fire. One panel stopped a full metal jacketed 200-gram bullet fired at a range of 50 feet from a .45 caliber handgun. Cloth layer 300 faced the oncoming projectile. Each of two panels stopped a projectile from a .22 caliber cartridge-loaded long rifle fired at a range of 50 feet. In one panel, resin layer 310 faced the oncoming projectile, and in the other panel, cloth layer 300 faced the oncoming projectile.

Preliminary tests suggest that higher velocity impact loads from rifle fire can be stopped by adding to the number of plies in the laminate, or by adding plates or other structures composed of ultra-hard strike-face materials to the structural preform.

1. An article which comprises an impact-resistant panel for protection against ballistic threats, wherein:
the panel comprises a laminated assembly of two or more layers;
at least one layer of the assembly comprises a cloth at least partially permeated with a thermoplastic resin; and
at least one layer of the assembly comprises an injection-molded plate of thermoplastic resin laminated to said cloth layer.

2. The article of claim 1, wherein at least one said cloth layer is laminated between two molded plates of thermoplastic resin.

3. The article of claim 1, wherein at least one layer of the assembly comprises a plate of strike-face material.

4. The article of claim 3, wherein the plate of strike-face material is laminated directly to at least one said cloth layer.

5. The article of claim 4, wherein the plate of strike-face material is laminated between and directly to two said cloth layers.

6. The article of claim 1, wherein at least one said molded plate of thermoplastic resin has a composition that comprises polycarbonate.

7. The article of claim 6, wherein said composition further comprises a synthetic rubber compound.

8. The article of claim 1, wherein at least one said cloth layer comprises woven fiberglass.

9. The article of claim 1, wherein at least one said cloth layer is at least partially permeated with polymethyl methacrylate and is directly laminated to at least one molded plate of a thermoplastic resin that comprises polycarbonate.

10. The article of claim 9, wherein the cloth layer comprises woven fiberglass.

11. The article of claim 1, wherein at least one said cloth layer is at least partially permeated with starch and is directly laminated to at least one molded plate of a thermoplastic resin that comprises polycarbonate.

12. The article of claim 11, wherein the cloth layer comprises woven fiberglass.

13. A method for manufacturing an impact-resistant article, comprising:
providing a preform that comprises woven cloth;
at least partially permeating the preform with a liquefied thermoplastic resin; and
overmolding the preform with a layer of thermoplastic resin.

14. The method of claim 13, wherein during the overmolding step, the preform is laminated to a plate of strike-face material.

15. The method of claim 13, wherein the permeating resin comprises polymethyl methacrylate, and the overmolded resin comprises polycarbonate.

16. The method of claim 13, wherein the overmolding step is carried out by high pressure injection molding.

17. The method of claim 13, wherein the overmolding step is carried out by low pressure injection molding.

18. The article of claim 1, wherein at least one said cloth layer is at least partially permeated with the thermoplastic resin is selected from the group consisting of starch, paraffin, wax, polymethyl methacrylate (PMMA), styrene, polymeric alloy, polyvinal, polybutane, polyester, and polyurethane.

19. The method of claim 13, wherein the thermoplastic that at least partially permeates the cloth is selected from the group consisting of starch, paraffin, wax, polymethyl methacrylate (PMMA), styrene, polymeric alloy, polyvinal, polybutane, polyester, and polyurethane.

20. (canceled)
